(19) United States
(12) Patent Application Publication
(10) Pub. No.: US 2018/0168006 A1
(43) Pub. Date: Jun. 14, 2018

(54) INDUCTION COOKING APPLIANCE AND METHOD OF ASSEMBLY

(71) Applicant: Haier US Appliance Solutions, Inc., Wilmington, DE (US)

(72) Inventor: Daniel Carballo, Louisville, KY (US)

(21) Appl. No.: 15/376,744

(22) Filed: Dec. 13, 2016

(51) Int. Cl. H05B 6/12; F24C 7/06; F24C 9/00

(52) U.S. Cl. CPC H05B 6/1281; F24C 7/067; H05B 2206/022; H05B 6/1209; F24C 9/00

(57) ABSTRACT

An induction cooking appliance and method of assembly is generally provided herein. The induction cooking appliance may include a cooktop, an induction element, a mount plate, and a coil bracket. The induction element may be positioned below the cooktop. The mount plate may be positioned below the induction element. The mount plate may include a top face and a bottom face. The mount plate may define a tab aperture extending through the mount plate from the top face to the bottom face. The coil bracket may support the induction element between an upper surface and the mount plate. The coil bracket may include a support body and an attachment tab. The support body may define an axis of rotation. The attachment tab may extend from the support body and through the tab aperture. The attachment tab may be slidably positioned to move along a circumferential direction.

### FIELD OF THE INVENTION

The present subject matter relates generally to induction cooking, and more particularly to mounting features and methods for induction cooking appliances.

### BACKGROUND OF THE INVENTION

Induction cooking appliances are generally more efficient, have greater temperature control precision and provide more uniform cooking than other conventional cooking appliances. In conventional cooktop systems, an electric or gas heat source is used to heat cookware in contact with the heat source. This type of cooking is inefficient because only the portion of the cookware in contact with the heat source is directly heated. The rest of the cookware is heated through conduction that causes non-uniform cooking throughout the cookware. Heating through conduction takes an extended period of time to reach a desired temperature.

In contrast, induction cooking systems use electromagnetism which turns cookware of the appropriate material into a heat source. A power supply provides a signal having a frequency to a coil of an induction element. When the coil is activated, a magnetic field is produced, which then induces a current on the bottom surface of the cookware. The induced current on the bottom surface induces even smaller currents (Eddy currents) within the cookware, thereby providing heat throughout the cookware.

Challenges exist with mounting certain elements, e.g., induction coils, of induction cooking appliances. Conventional systems often use discrete fasteners, such as screws or clamps, to secure elements below a cooktop surface. Such systems may require significant assembly time and material, increasing cost and overall difficulty of assembly. Specialized tools and/or training may be needed to ensure assembly methods are performed correctly. Moreover, the forces generated by conventional fasteners may be in excess of what would otherwise be desirable for mounting various elements.

Accordingly, improved methods and apparatuses for mounting induction elements within induction cooking appliances, and generally for assembling such induction cooking appliances, are desired. Specifically, methods and apparatuses that are simple, efficient, and do not require multiple discrete fasteners would be advantageous.

### BRIEF DESCRIPTION OF THE INVENTION

Aspects and advantages of the invention will be set forth in part in the following description, or may be obvious from the description, or may be learned through practice of the invention.

In one aspect of the present disclosure an induction cooking appliance is provided. The induction cooking appliance may define a vertical direction and include a cooktop, an induction element, a mount plate, and a coil bracket. The cooktop may have an upper surface and an opposing lower surface. The induction element may be positioned below the cooktop in the vertical direction. The mount plate may be positioned below the induction element in the vertical direction. The mount plate may include a top face and an opposing bottom face. The mount plate may define a tab aperture extending through the mount plate from the top face to the bottom face. The coil bracket may support the induction element between the upper surface and the mount plate. The coil bracket may include a support body and an attachment tab. The support body may be positioned above the top face and define an axis of rotation. The attachment tab may extend from the support body and through the tab aperture. The attachment tab may be slidably positioned to move along a circumferential direction below the bottom face.

In another aspect of the present disclosure, a method of assembling an induction cooking appliance is provided. The method may include positioning a coil bracket over a top face of a mount plate in alignment with a tab aperture, inserting an attachment tab of the coil bracket through the tab aperture defined by the mount plate, and rotating the coil bracket about an axis of rotation from an unsecured position to a secured position. Rotating may include sliding a neck of the attachment tab within the tab aperture and sliding a retention leg along a circumferential direction below a bottom face of the mount plate.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a top perspective view of an induction cooking appliance according to example embodiments of the present disclosure.

FIG. 2 provides a cross-sectional assembled view of a portion of an induction cooking appliance according to example embodiments of the present disclosure.

FIG. 3 provides an exploded perspective view of an induction element according to example embodiments of the present disclosure.

FIG. 4 provides a bottom view of the example coil bracket of the embodiments of FIG. 3.

FIG. 5 provides a side view of the example coil bracket of the embodiments of FIG. 3.

FIG. 6 provides a bottom view of the example mount plate of the embodiments of FIG. 3.

FIG. 7 provides a bottom perspective view of the example assembly of the embodiments of FIG. 3, wherein the coil bracket is provided in an unsecured position.

FIG. 8 provides a bottom perspective view of the example assembly of the embodiments of FIG. 3, wherein the coil bracket is provided a secured position.

FIG. 9 provides a flow chart illustrating a method of assembling an induction cooking appliance according to example embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure provides an induction cooking appliance and method of assembling the same. The induction cooking appliance may include, among other things, a coil bracket that can be attached or mounted to a mount plate. The coil bracket may include one or more attachment tabs. The attachment tabs can be inserted through the mount plate and rotated from an unsecured position to a secured position. In the secured position, the coil bracket rests on top of the mount plate while the attachment tabs extend below the mount plate so that movement of the coil bracket is generally restricted.

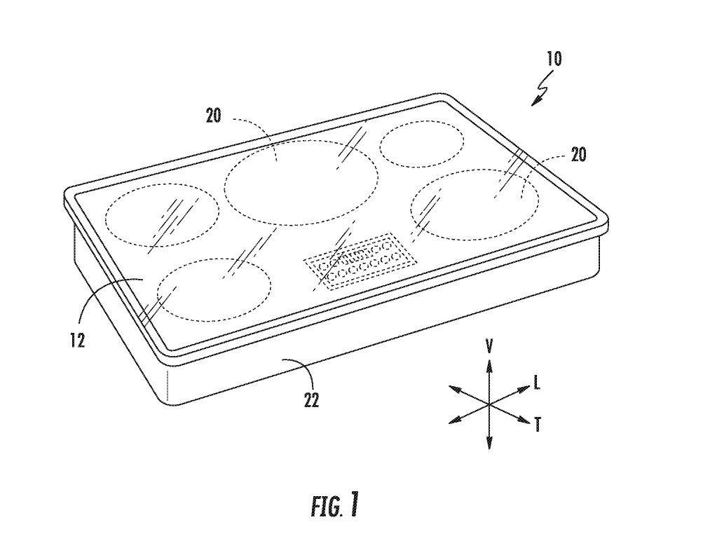

FIG. 1 provides an exemplary embodiment of an induction cooking appliance 10 of the present invention. As shown, the induction cooking appliance 10 defines a vertical direction V, a lateral direction L, and a transverse direction T. These directions are each generally perpendicular to each other, thus forming an orthogonal coordinate system. Induction cooking appliance 10 may be installed in various configurations such as in cabinetry in a kitchen and/or coupled with one or more ovens or as a stand-alone appliance.

As illustrated in FIG. 1, appliance 10 may for example include a cooktop 12. The cooktop 12 may be formed from glass or another suitable surface, and may generally extend within a plane defined by the lateral and transverse axes L, T. Items for cooking, such as pots and pans, may be placed on an upper surface 14 of the cooktop 12 for heating. Cooktop 12 may additionally include an opposing lower surface 16 that is opposite the upper surface 14.

As discussed in detail herein, one or more induction elements 20 may be positioned below the cooktop 12 in the vertical direction V. A housing 22 may generally surround the induction elements 20, as well as various other components as discussed therein.

Appliance 10, as illustrated in FIG. 1, is provided by way of example only. The present disclosure may encompass or be used with other configurations, such as, for example, an appliance having one or more induction elements in combination with one or more electric or gas burner assemblies. In addition, the present disclosure may also encompass or be used with a cooktop having a different number and/or positions of induction elements.

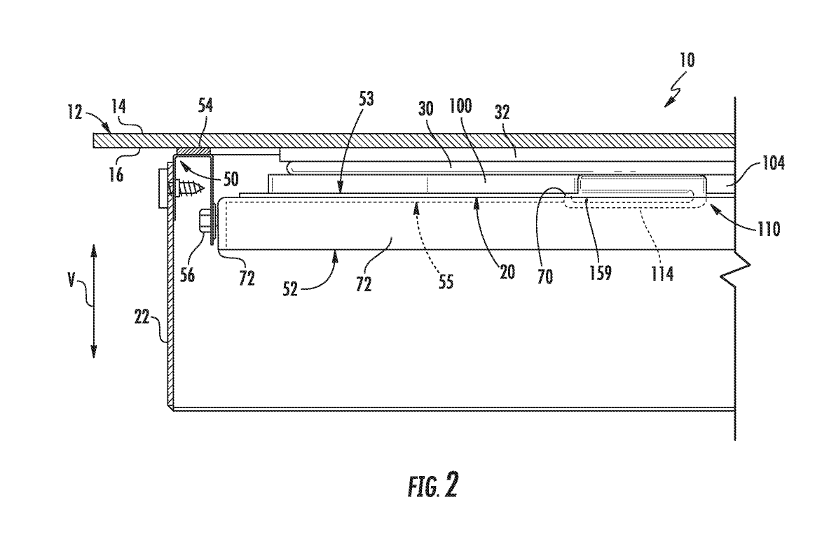

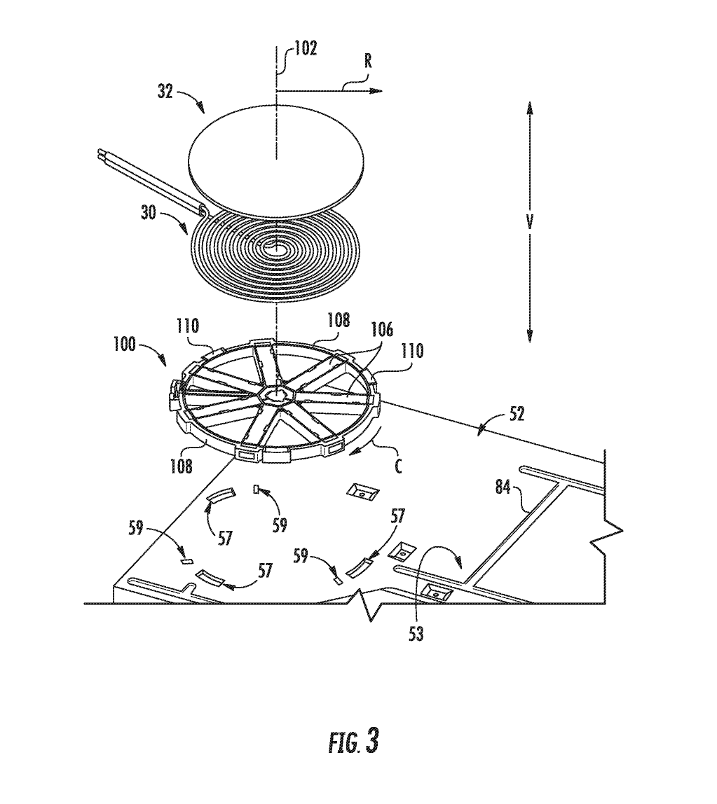

FIG. 2 provides a side view of various components of an induction cooking appliance 10, and FIG. 3 provides an exploded view of an induction assembly 20 for use in an appliance 10. As shown, induction assembly 20 may include, for example, an induction element 30. Optionally, induction element 30 may be formed as a coil, as illustrated. The element 30 may be in communication with an electrical power source, and may produce an electromagnetic field, as is generally understood. An insulation layer 32 may be provided vertically above the element 30, and may be formed, for example, at least partially from fiberglass, e.g., as a fiberglass substrate. Additionally or alternatively, insulation layer 32 may include an electrical isolator, e.g., a mica laminate positioned above the fiberglass substrate.

A coil bracket 100 may be provided below induction element 30 to support various elements of induction assembly 20. Specifically, induction element 30 and/or or insulation layer 32 may rest above coil bracket 100, e.g., along the vertical direction V. As shown, coil bracket 100 may define a rotation axis 102 about which a support body 104 extends. In some embodiments, rotation axis 102 is defined parallel to the vertical direction V on the assembled appliance 10. In certain embodiments, a plurality of spokes 106 extends in a radial direction R from rotation axis 102. Optionally, one or more ferrite bars (not pictured) may be provided or mounted in the spokes 106. When assembled, the ferrite bar(s) may be positioned vertically below the element 30. The ferrite bar(s) may block electromagnetic flow therethrough, thus directing the flow vertically upward.

In additional or alternative embodiments, support body 104 includes a perimeter ring or band 108. Perimeter band 108 may extend along a circumferential direction C defined relative to the rotation axis 102. One or more attachment tabs 110 generally extend from support body 104, e.g., at perimeter band 108. Specifically, each attachment tab 110 may extend from support body 104 along the radial direction R. Additionally or alternatively, each attachment tab 110 may extend from support body 104 parallel to the rotation axis 102, e.g., along the vertical direction V. As will be described in greater detail below, during assembly/disassembly support body 104 may be pivoted or rotated about rotation axis 102. During rotation, attachment tabs 110 may thus move or slide along the circumferential direction C, e.g., to engage with another portion of appliance 10.

Coil bracket 100 may be formed from any suitable material. For instance, coil bracket 100 may be formed from a substantially insulating material. Specific embodiments of coil bracket 100 are from a resilient plastic material, such as Polyphenylene sulfide. Optionally, coil bracket 100 may be a single integral or unitary member, e.g., formed by injection molding.

When assembled, a portion of each induction assembly 20 extends below and/or contacts the lower surface 16 of the cooktop 12. For instance, induction element 30 may be positioned below lower surface 16 of cooktop 12 in the vertical direction V. A portion of the insulation layer, e.g., electrical isolator, may directly contact lower surface 16.

Further, the present disclosure is directed to various components for advantageously supporting the induction assemblies 20 relative to the cooktop 12. In particular, such components may support the induction assemblies 20 relative to the cooktop 12 without utilizing any biasing forces, such as from spring-like features. Such components and resulting appliance are advantageously more efficient and easier to assemble, and further have less risk of damage or deformity during use.

Referring still to FIGS. 2 and 3, cooking appliance 10 may include a mount plate 52 positioned below induction element 30 in the vertical direction V. When assembled, mount plate 52 may support one or more coil brackets 100 mounted thereon. Mount plate 52 defines multiple mounting surfaces, including a top face 53 and an opposing bottom face 55. Moreover, mount plate 52 defines one or more tab apertures 57 extending through mount plate 52 from the top face 53 to the bottom face 55, e.g., in the vertical direction V. As will be described in detail in below, each tab aperture 57 is configured to receive a portion of coil bracket 100 during and/or after assembly.

In some embodiments, one or more mount brackets 50 are provided. For instance, mount brackets may be provide in attachment with mount plate 52. As shown, each mount bracket 50 may be connected to the lower surface 16 of the cooktop 12. One mount plate 52 may be connected to one or more mount brackets 50, which may thus support the mount plate 52 relative to the cooktop 12. When assembled, and as shown, the mount plate 52 may thus be positioned below one or more induction elements 20 in the vertical direction V. Further, one or more induction elements 20 may be connected to the mount plate 52. The mount brackets 50 and the mount plates 52 may generally support the one or more induction elements 20 relative to the cooktop 12, such that each induction element 20 is advantageously in contact with the lower surface 16 of the cooktop 12. In some embodiments, an induction element 20 is positioned directly between, and in contact with, the lower surface 16 of the cooktop 12 and a mount plate 52. The mount brackets 50 and mount plates 52 may thus generally hold the induction elements 20 relative to and in contact with the cooktop 12.

In optional embodiments, an adhesive 54 may be utilized to connect a mount bracket 50 and the lower surface 16 of the cooktop 12. The adhesive 54 may, for example, be a suitable silicone adhesive. Adhesive 54 may form a layer between mount bracket 50 and lower surface 16. Moreover, adhesive 54 may connect mount bracket 50 directly to lower surface 16. Alternatively, other suitable methods or apparatus may be utilized to connect the mount bracket 50 and the lower surface 16. For example, suitable mechanical fasteners may be utilized, or welding, brazing, or other suitable methods may be utilized.

As further illustrated, in example embodiments, one or more mechanical fasteners 56 may be utilized to connect a mount plate 52 and a mount bracket 50. Suitable mechanical fasteners include, for example, screws, nails, rivets, nut/bolt combinations, etc. A mechanical fastener 56 may generally extend through the mount plate 52 and mount bracket 50 to connect these components together. Alternatively, other suitable methods or apparatus may be utilized to connect the mount plate 52 and mount bracket 50. For example, an adhesive may be utilized, or welding, brazing, or other suitable methods may be utilized.

As further shown, mount plate 52 may include two or more portions. For example, mount bracket 50 may include a first plate 70 and one or more second plates 72 which are generally perpendicular to each other. The first plate 70 may, for example, be generally oriented within a plane defined by the lateral direction L and the transverse direction L. Each second plate 72 may, for example, extend generally perpendicularly from the first plate 70 generally along the vertical direction V. Embossing features 84 may be included and defined in the mount plate 52, such as in the first plate 70 thereof. The embossing features 84 may generally be thin channels defined in the mount plate 50, such as the first plate 70 thereof. Such embossing features 84 may generally strengthen the mount plate 52 and reduce bowing and/or deformation during use in the appliance 10.

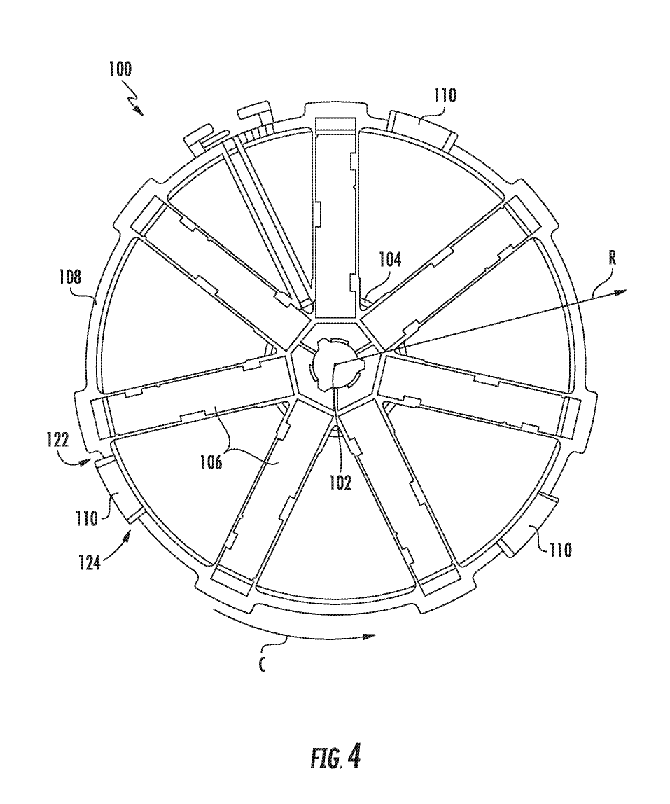

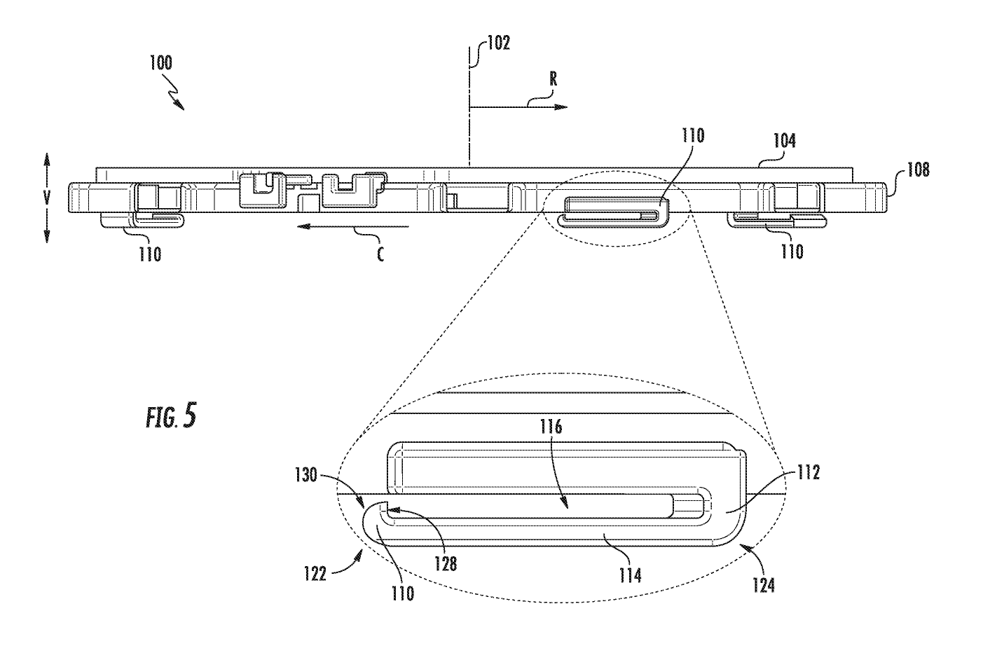

As shown in FIGS. 4 and 5, some embodiments of coil bracket 100 include a plurality of spokes 106 extending in the radial direction R from rotation axis 102. Perimeter band 108 extends along the circumferential direction C and connects, for example, the radial extremes of the spokes 106. A plurality of attachment tabs 110 extend from perimeter band 108. In certain embodiments, attachment tabs 110 extend downward in the vertical direction V from, and below, perimeter band 108. Additionally or alternatively, attachment tabs 110 may extend outward in the radial direction R from perimeter band 108. At least a portion of each attachment tab 110 may thus extend further in the radial direction R than perimeter band 108 or, at least, an adjacent portion thereof.

Each of the plurality of attachment tabs 110 may be spaced apart along the circumferential direction C. The circumferential space between each attachment tab 110 may equal to each other. For example, three attachment tabs 110 may extend from discrete portions of support body 104 that are spaced from the rotation axis 102 by the same radial distance. Each attachment tab 110 may be circumferentially spaced from every adjacent attachment tab 110 by the same angle (e.g., 120°) relative to the rotation axis 102. Alternatively, each attachment tab 110 may be spaced by a unique angle relative to the rotation axis 102. Advantageously, unique spacing between each of a plurality of attachment tabs 110 may force coil bracket 100 to be mounted in a single desired orientation (i.e., position).

As shown, each attachment tab 110 includes a neck 112 and a retention leg 114. In certain embodiments, the neck 112 extends parallel to the rotation axis 102. As an example, neck 112 may extend below the support body 104 along the vertical direction V. The retention leg 114 extends generally from the neck 112. In some embodiments, retention leg 114 extends horizontally, e.g., in the circumferential direction C perpendicular to the vertical direction V. Thus retention leg 114 may be parallel to the support body 104 that is positioned above retention leg 114. In certain embodiments, a tab channel 116 is defined above retention leg 114. Specifically, tab channel 116 may be defined between support body 104 and retention leg 114. Tab channel 116 may extend circumferentially from a first circumferential end 122 to a second circumferential end 124. First circumferential end 122 of tab channel 116 may be generally open (e.g., unobstructed) while second circumferential end 124 is bounded by neck 112.

In optional embodiments, a positioning tooth 126 extends from retention leg 114. For instance, positioning tooth 126 may extend above retention leg 114 along the rotation axis 102, e.g., upward in the vertical direction V toward support body 104. Optionally, a flat restrictor surface 128 of positioning tooth 126 may face neck 112. In other words, flat restrictor surface 128 may be generally directed toward neck 112 in the circumferential direction C. Another portion of positioning tooth, e.g., an opposite surface, may be formed as an arcuate biasing surface 130. For instance, arcuate biasing surface 130 may face away from neck 112. In some embodiments, such as those shown, a positioning tooth 126 is positioned at the first circumferential end 122. However, alternative embodiments of positioning tooth 126 may be positioned at another location along retention leg 114 between the first circumferential end 122 and the second circumferential end 124.

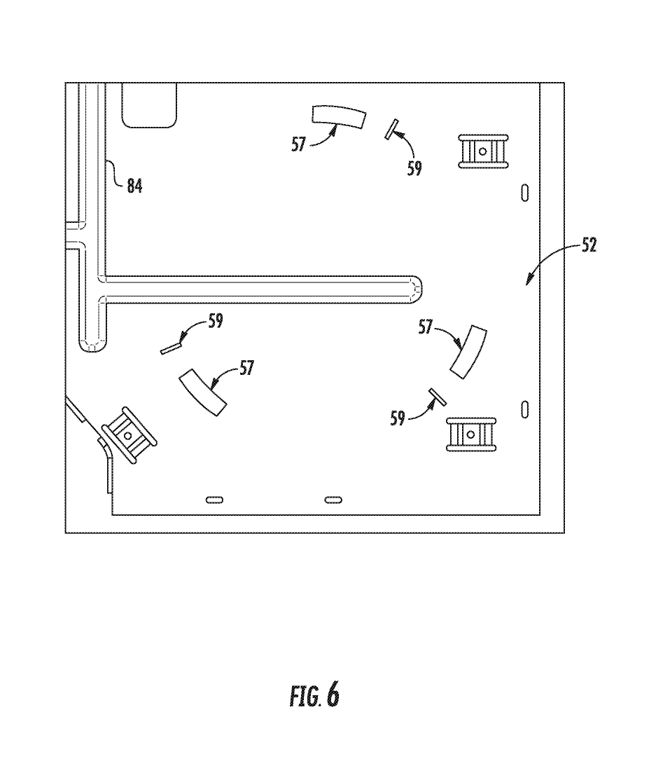

Turning now to FIGS. 2 and 6 through 8, attachment of induction assembly 20 to mounting plate will be described. As shown, mount plate 52 includes one or more tab apertures 57. Each tab aperture 57 may correspond to a discrete attachment tab 110 of coil bracket 100. The positioning of the tab apertures 57 is thus matched to the desired or assembled positioning of the attachment tabs 110. In turn, each tab aperture 57 may receive a discrete attachment tab 110 therethrough. In embodiments wherein a plurality of attachment tabs 110 are included and spaced apart from each other, a plurality of tab apertures 57 may be provided and equally spaced apart from each other, e.g., along the circumferential direction C.

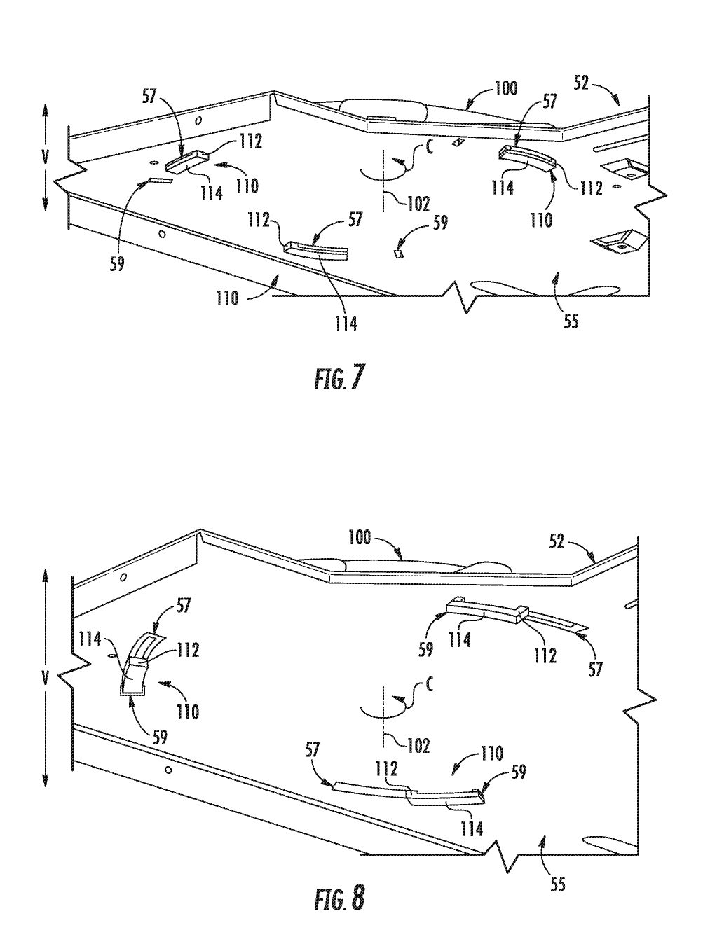

When assembled, a portion of each attachment tab 110 may extend through a corresponding tab aperture 57. Specifically, neck 112 may extend from above the top face 53 of mount plate 52 to below the bottom face 55 of mount plate 52. Support body 104 may be positioned on or above top face 53, while retention leg 114 is positioned on or below bottom face 55. Neck 112 is slidably received by tab aperture 57 to allow rotation of coil bracket 100 about rotation axis 102. When positioned on mount plate 52, coil bracket 100 may thus rotate between an unsecured position (FIGS. 2 and 7) and a secured position (FIG. 8).

As shown in FIG. 7, the unsecured position provides the retention leg 114 in circumferential alignment with tab aperture 57. Although support body 104 may be disposed on top face 53, retention leg 114 and positioning tooth 126 may be otherwise unengaged and out of contact with any portion of mount plate 52. Thus, coil bracket 100 may be generally unrestricted from moving vertically above mount plate 52.

As shown in FIG. 8, the secured position provides the retention leg 114 offset from the tab aperture 57 along the circumferential direction C. Specifically, retention leg 114 extends directly below bottom face 55. Neck 112 remains slidably positioned within tab aperture 57. In some embodiments, lock channel 59 receives positioning tooth 126. Optionally, flat restrictor surface 128 faces and may engage an internal wall 159 of lock channel 59 in the secured position. The bottom surface of mount plate 52 blocks retention leg 114 to prevent upward vertical movement of coil bracket 100 while the internal wall 159 of lock channel 59 restricts circumferential movement of coil bracket 100.

Retention leg 114 may be provided as a resilient member capable of deflecting downward away from support body 104 before elastically returning to its original, non-deflected position. As noted above, coil bracket 100, including retention leg 114, may be formed from a resilient plastic material, such as Polyphenylene sulfide. Engagement between mount plate 52 and positioning tooth 126, e.g., at arcuate biasing surface 130, may deflect retention leg 114 as coil bracket 100 rotates between the unsecured and secured positions. In some embodiments, lock channel 59 extends from top face 53 to bottom face 55. In turn, in order to move coil bracket 100 from the secured position, a user or installer may actuate or motivate positioning tooth 126 downward from the top face 53. Actuating positioning tooth 126 downward may force positioning tooth 126 out of lock channel 59, thereby permitting circumferential movement of coil bracket 100 to the unsecured position. Advantageously, retention leg 114 may secure induction assembly 30 (FIG. 2) to mounting plate 52 without the need or use of separate fasteners or clamps.

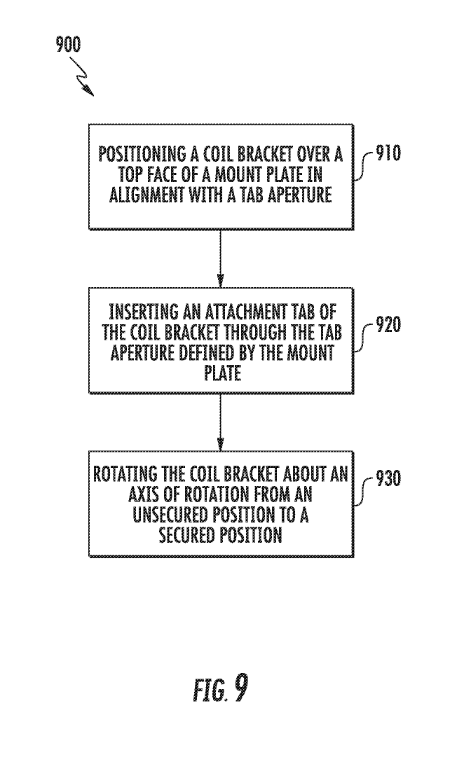

Turning now to FIG. 9, a flow chart illustrating a method 900 of assembling an induction cooking appliance in accordance with example embodiments of the present disclosure. Induction cooking appliance may be, for example, induction cooking appliance 10 described above with respect to FIGS. 1 through 8.

At 910, method 900 may include positioning a coil bracket over a top face of a mount plate in alignment with a tab aperture. The tab aperture may extend through the mount plate from a top face to a bottom face, as described above. Moreover, the coil bracket may be an integral plastic member. As such, method may include forming the coil bracket, such as by injection molding.

At 920, method 900 may include inserting an attachment tab of the coil bracket through the tab aperture defined by the mount plate. In some embodiments, 920 brings coil bracket into an unsecured position. The unsecured position may include a retention leg in circumferential alignment with the tab aperture. Moreover, a neck of the attachment tab may extend through the tab aperture between a support body of the coil bracket and the retention leg. The support body may be positioned above the top face while the retention leg is below the bottom face. As a result, inserting may include moving the coil bracket primarily in a vertical direction.

At 930, the method 900 may include rotating the coil bracket about an axis of rotation from the unsecured position to a secured position. The rotation may be, for example, perpendicular to the vertical direction. In some embodiments, 930 includes sliding the neck of the attachment tab within the tab aperture and sliding the retention leg along a circumferential direction below a bottom face of the mount plate. In other words, rotation of the coil bracket causes simultaneous rotation of the attachment tab neck and retention leg about the axis of rotation.

In the secured position, the retention leg may be offset from the tab aperture along the circumferential direction, as described above. As described above, the attachment leg may include a positioning tooth formed to compliment a lock channel. In turn, 930 may include inserting the positioning tooth into the lock channel at the secured position. The secured position may align a flat restrictor surface of the positioning tooth with an internal wall of the lock channel.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An induction cooking appliance, the induction cooking appliance defining a vertical direction and comprising:
a cooktop having an upper surface and an opposing lower surface;
an induction element positioned below the cooktop in the vertical direction;
a mount plate positioned below the induction element in the vertical direction, the mount plate including a top face and an opposing bottom face, the mount plate defining a tab aperture extending through the mount plate from the top face to the bottom face; and
a coil bracket supporting the induction element between the upper surface and the mount plate, the coil bracket including a support body and an attachment tab, the support body being positioned above the top face and defining an axis of rotation, the attachment tab extending from the support body and through the tab aperture, the attachment tab being slidably positioned to move along a circumferential direction below the bottom face.

2. The induction cooking appliance of claim 1, wherein the attachment tab includes a neck slidably positioned within the tab aperture, and a retention leg extending from the neck along the circumferential direction below the bottom face.

3. The induction cooking appliance of claim 2, wherein the coil bracket is rotatable about the axis of rotation between an unsecured position and a secured position, wherein the unsecured position includes the retention leg in circumferential alignment with the tab aperture, and wherein the secured position includes the retention leg offset from the tab aperture along the circumferential direction.

4. The induction cooking appliance of claim 3, wherein the attachment tab includes a positioning tooth extending from the retention leg along the vertical direction.

5. The induction cooking appliance of claim 4, wherein the mount plate further defines a lock channel to receive the positioning tooth in the secured position.

6. The induction cooking appliance of claim 5, wherein lock channel extends through mount plate from the bottom face to the top face.

7. The induction cooking appliance of claim 5, wherein the mount plate includes an internal wall along lock channel, and wherein the positioning tooth includes a flat restrictor surface facing the neck to engage the internal wall in the secured position.

8. The induction cooking appliance of claim 4, wherein the positioning tooth includes an arcuate biasing surface facing away from the neck to guide the retention leg away from the bottom face between the secured position and the unsecured position.

9. The induction cooking appliance of claim 2, wherein the axis of rotation is parallel to the vertical direction, and wherein the neck extends along the vertical direction.

10. The induction cooking appliance of claim 1, wherein the coil bracket is formed from plastic.

11. The induction cooking appliance of claim 1, wherein the tab aperture is a first aperture and the attachment tab is a first attachment tab, and wherein the induction cooking appliance further comprises a plurality of attachment tabs and tab apertures defined by the mount plate, each of the plurality of attachment tabs extending in the radial direction from the support body and through a corresponding tab aperture of the plurality of tab apertures.

12. A method of assembling an induction cooking appliance, the method comprising:
positioning a coil bracket over a top face of a mount plate in alignment with a tab aperture;
inserting an attachment tab of the coil bracket through the tab aperture defined by the mount plate; and
rotating the coil bracket about an axis of rotation from an unsecured position to a secured position, including sliding a neck of the attachment tab within the tab aperture and sliding a retention leg along a circumferential direction below a bottom face of the mount plate.

13. The method of claim 12, wherein the unsecured position includes the retention leg in circumferential alignment with the tab aperture, and wherein the secured position includes the retention leg offset from the tab aperture along the circumferential direction.

14. The method of claim 12, wherein the attachment tab includes a positioning tooth extending from the retention leg along the vertical direction, and wherein the mount plate further defines a lock channel, and wherein rotating the coil bracket further includes inserting the positioning tooth into the lock channel at the secured position.

15. The method of claim 14, wherein the mount plate includes an internal wall along lock channel, wherein the positioning tooth includes a flat restrictor surface facing the neck, and wherein rotating the coil further comprises aligning the flat restrictor surface in engagement with the to engage the internal wall at the secured position.

16. The method of claim 14, wherein the positioning tooth includes an arcuate biasing surface facing away from the neck, and wherein rotating the coil bracket further comprises sliding the arcuate biasing surface along the bottom face between the unsecured position and the secured position.

17. The method of claim 12, wherein rotating the coil bracket includes rotating the coil bracket perpendicular to the vertical direction.

18. The method of claim 12, wherein the coil bracket includes a support body, wherein the attachment tab extends in a radial direction from the support body, and wherein the method further comprises forming the support body from plastic.
